(19) United States
(12) Patent Application Publication
(10) Pub. No.: US 2013/0049743 A1
(43) Pub. Date: Feb. 28, 2013

(54) FLOAT POSITION SENSOR

(71) Applicant: Katsutoshi Sawano, Toyko (JP)

(72) Inventor: Katsutoshi Sawano, Toyko (JP)

(73) Assignee: TOFLO CORPORATION, Hino-shi (JP)

(21) Appl. No.: 13/639,226

(22) PCT Filed: Apr. 8, 2011
(86) PCT No.: PCT/JP2011/002091

§ 371 Date: Oct. 4, 2012

(30) Foreign Application Priority Data
Apr. 13, 2010 (JP) 2010-092252

(51) Int. Cl. G01B 7/14

(52) U.S. Cl. 324/207.24

(57) ABSTRACT

[Problem] To provide a float position sensor with a simple structure in which, even when a float is moved after the power is turned off, adjustment is not particularly necessary when the power is turned on next time.

[Means for Resolution] A float position sensor including a float and a magnetic sensor provided in a lateral direction with respect to a movement direction of the float for detecting a change of a magnetic field caused by movement of the float, characterized in that the change of the magnetic field caused by the movement of the float is detected by the magnetic sensor through a movable magnet provided in the vicinity of the magnetic sensor.

### TECHNICAL FIELD

The present invention relates to a position sensor using a float to be used for a variable area flowmeter, a liquid-level meter and so on.

### BACKGROUND ART

There exists a variable area flowmeter having a float position sensor in related arts (Patent Documents 1 and 2) as shown in FIG. 1. A float 1 is arranged inside a pipe 2 formed so that an inside diameter gradually becomes larger toward an upper position. The float 1 floats upward as a flow rate of fluid passing through the pipe 2 from a lower position to an upper position is increased and stops at a position where the empty weight thereof balances with a force of fluid being pushed up, and the flow rate can be measured at the position.

The variable area flowmeter described above is provided with a magnetic sensor 3 on an outer wall of the pipe 2 the flow rate of which is desired to be detected, outputting a signal from a switch circuit 4, which indicates whether the flow rate of fluid inside the pipe 2 is higher or lower than a set flow rate by detecting passing of the float 1.

In the case of the above variable area flowmeter, a magnet 5 is normally included inside the float 1, detecting passing of the float 1 magnetically or optically.

As a magnetic detection method, a magnetic proximity switch such as a reed switch, a Hall IC, MR/GMR magnetic sensor is used, and a bipolar-type magnetic sensor which can discriminate between N-pole and S-pole is applied as the magnetic sensor. In the structure shown in FIG. 1, the polarity of magnetism applied on the magnetic sensor 3 is changed when the magnet 5 in the float 1 passes near the magnetic sensor 3, and the change of the polarity is detected by a comparator 6.

The upper side of FIG. 2 schematically shows a positional relationship between the magnetic sensor 3 and the comparator 6 when the float 1 moves from the upper position to the lower position (magneto-sensitive axis) in the pipe 2, and the lower side shows an output of the magnetic sensor 3 and an output of the comparator 6.

The output is maintained as long as the float 1 is positioned lower than the magnetic sensor 3 even when the float 1 moves away from the magnetic sensor 3 due to hysteresis of the comparator 6. Subsequently, when the float 1 moves upward from the lower position to the upper position than the magnetic sensor 3, the output of the comparator 6 is inverted.

The related-art position sensor has the following inconvenience. The flowmeter installed in the actual scene and put into practice is mechanical and operates without power supply as the flowmeter is the area-variable type. On the other hand, the magnetic sensor 3 is electrical and power supply is essential. If the power is cut off due to a certain circumstance, the flowmeter starts from an initial state when the power is turned on next time unless the float is positioned near the magnetic sensor 3. That is, it is inevitably necessary to perform initial adjustment when the power is temporarily cut off. After the power is turned on, it is necessary to make the float 1 pass through the vicinity of the magnetic sensor 3 to thereby allow the status to be consistent, for example, by performing an operation of stopping the flow of fluid once and allowing the fluid to flow again.

A method of storing the status in a nonvolatile memory when the status such as power on/off is changed can be considered, however, there is a problem that status inconsistency may occur when the power is turned on next time in the case where the float 1 moves before and after the power on/off.

Also in the liquid-level meter, just the same inconvenience occurs in the method of determining the float position magnetically.

### PRIOR ART DOCUMENTS

### Patent Document

Patent Document 1: JP-UM-A-62-9132

Patent Document 2: JP-UM-A-63-2123

### SUMMARY OF THE INVENTION

### Problems that the Invention is to Solve

Accordingly, an object of the present invention is to provide a float position sensor with a simple structure in which, even when the float is moved after the power is turned off, adjustment is not particularly necessary when the power is turned on next time.

### Means for Solving the Problems

A first resolution of the float position sensor according to the present invention is a float position sensor including a float and a magnetic sensor provided in a lateral direction with respect to a movement direction of the float for detecting a change of a magnetic field caused by movement of the float, characterized in that the change of the magnetic field caused by the movement of the float is detected by the magnetic sensor through a movable magnet provided in the vicinity of the magnetic sensor.

A second resolution is characterized in that, in the first resolution, the movable magnet is provided between the movement direction of the float and the magnetic sensor, or on the opposite side of the magnetic sensor with respect to the float.

A third resolution is characterized in that, in the first or second resolution, the magnet is pivotally supported to be rotatable by an axis parallel to the movement direction of the float.

A fourth resolution is characterized in that, in the first to third resolutions, the magnet is arranged in a casing for controlling movement in a direction coming close to or a direction moving away from the movement direction of the float.

A fifth resolution is characterized in that, in the fourth resolution, a protrusion for controlling a range in which the magnet is rotated is provided on an inner wall of the casing.

A sixth resolution is characterized in that, in the first to fifth resolutions, the magnet is a columnar or disc-shaped multipolar magnet.

A seventh resolution is characterized in that, in the first to sixth resolutions, end portions on pole's sides of the magnet are formed in a cone shape or a spherical shape.

An eighth resolution is characterized in that, in the first to seventh resolutions, the magnet is formed so that a line connecting between both poles is bent.

### Advantage of the Invention

According to the present invention, it is possible to provide a float position sensor in which, even when the float is moved at the time of on/off of the power and so on, adjustment is not necessary at the next measurement.

### BRIEF DESCRIPTION OF THE DRAWINGS

FIG. 1 is a cross-sectional view for explaining a structure of a related-art float position sensor.

FIG. 2 is an explanatory view of an output of the sensor and an output of a comparator.

FIG. 3 is an explanatory view of a float position sensor according to an embodiment of the present invention ((a) is a plan view and (b) is a side view).

FIG. 4 is an explanatory view of an axis structure of the float position sensor.

FIG. 5 is an explanatory view of rotation of a magnet in a mode of FIG. 3.

FIG. 6 is an explanatory view of a float position sensor according to another embodiment of the present invention.

FIG. 7 is an explanatory view of rotation of a magnet in a mode of FIG. 6.

FIG. 8 is an explanatory view of a float position sensor according to another embodiment of the present invention.

FIG. 9 is an explanatory view of rotation of a magnet in a mode of FIG. 8.

FIG. 10 is an explanatory view of an example in which rotation of the magnet is limited.

FIG. 11 is an explanatory view of end portions of a magnet according to another embodiment of the present invention.

FIG. 12 is an explanatory view of end portions of a magnet according to another embodiment of the present invention.

FIG. 13 is an explanatory view of a shape of a magnet according to another embodiment of the present invention.

FIG. 14 is an explanatory view of a shape of a magnet according to another embodiment of the present invention.

FIG. 15 is an explanatory view of rotation of a magnet having the shape shown in FIG. 14.

FIG. 16 is an explanatory view of rotation of a magnet in the case where a protrusion is provided on an inner wall of a casing.

FIG. 17 is an explanatory view of rotation of a magnet according to another embodiment in the case where a protrusion is provided on an inner wall of a casing.

FIG. 18 is an explanatory view of magnetic force lines of a magnet and a magneto-sensitive axis of a magnetic sensor according to an embodiment of the present invention.

FIG. 19 is a view showing a positional relationship between a magnet and a magnetic sensor according to an embodiment of the present invention.

FIG. 20 is an explanatory view of movement of a float and a magnetic field received by a magnetic sensor in a float position sensor according to an embodiment of the present invention.

FIG. 21 is an explanatory view in the case where on/off of the power is performed in the process of FIG. 20.

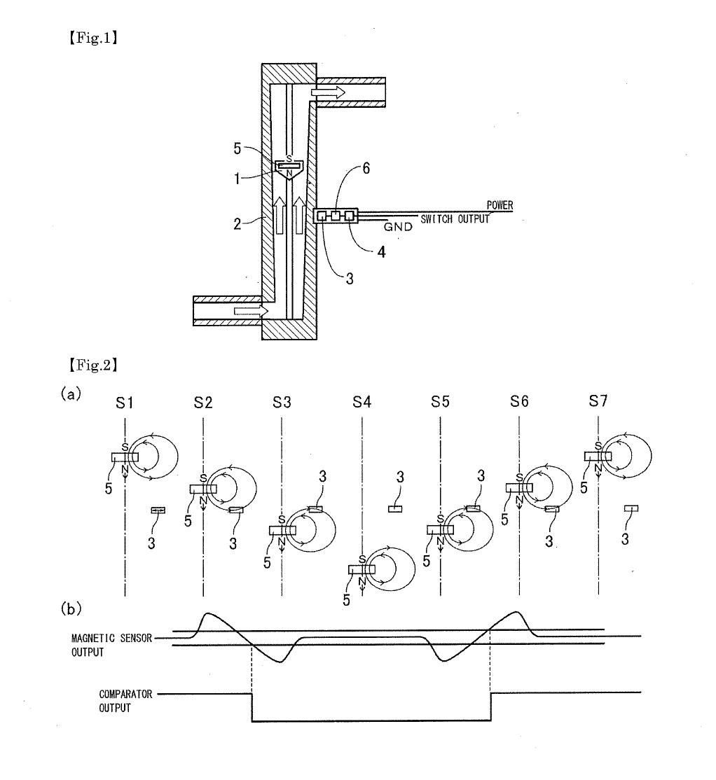

### MODE FOR CARRYING OUT THE INVENTION

Next, an embodiment of the present invention will be explained.

FIG. 3 shows a basic structure of a float position sensor according to an embodiment of the present invention. A float 1 including a magnet 5 inside is provided in the pipe 2 so as to move with the movement of fluid. The magnet 5 in the float 1 is set so that S-pole and N-pole point in a movement direction of fluid, and so that the upper side is S-pole and the lower side is N-pole in the drawing. The float 1 is not particularly limited as long as having magnetism, and the float 1 itself can be made of a magnetic material.

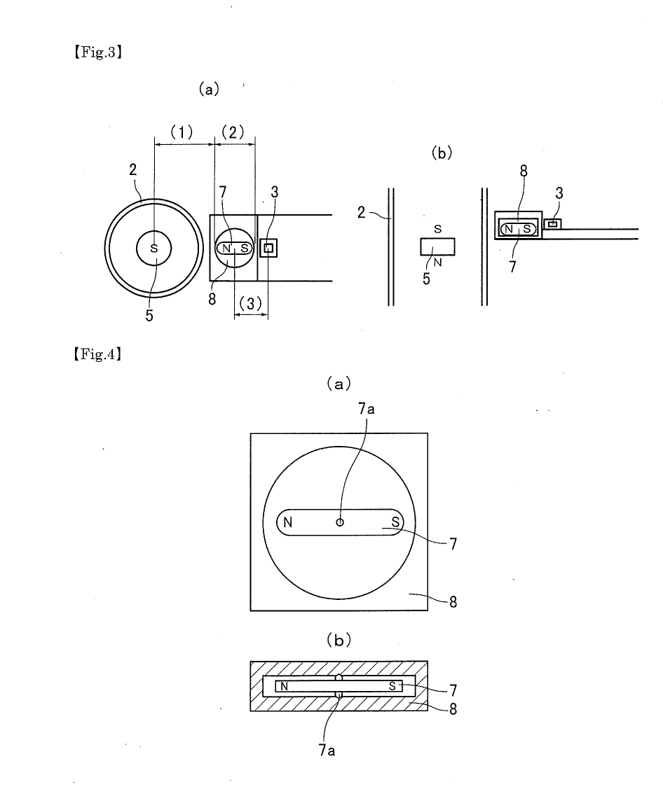

A magnetic sensor 3 is provided in a lateral direction with respect to the pipe 2, namely, a movement direction of the float 1. A magnet 7 is arranged between the magnetic sensor 3 and a side surface of the pipe 2, the magnet 7 being pivotally supported at the center in the longitudinal direction of the magnet 7 by a rotation axis 7a parallel to the movement direction of the float 1 so as to be rotatable in a horizontal surface around the rotation axis 7a as shown in FIG. 4.

It is possible to dispense with the axis in the magnet 7 when a bar magnet or a needle magnet is used as the magnet 7. This is because these magnets have a small static friction coefficient as a touch area is small. For example, stable operation has been confirmed in a structure in which the float 1 having magnetism of approximately 1000 gauss in surface magnetic flux density is combined with the magnet 7 of 2 mm×2 mm×6 mm with 700 gauss in which tips are formed in a spherical shape, and the magnet 7 not having the axis is shut in a space of 7 mm in internal diameter and 3 mm in height.

As the magnetic sensor 3, a Hall device, a Hall IC, a MR magnetic sensor, a GMR magnetic sensor and so on can be used.

It is preferable to provide the magnet 7 inside a casing 8. This is for preventing the magnet 7 from moving in a direction coming close to the float 1 or a direction moving away from the float 1 due to a magnetic force of the float 1. It is also preferable to form the casing 8 in a cylindrical shape when the magnet 7 is arranged inside the casing 8, so that the magnet 7 is smoothly rotated.

In the above structure, from the initial state shown in FIGS. 5(a) and (b), the magnet 7 is rotated in the horizontal surface and the orientation of the magnet 7 is changed with respect to the initial state due to change of a surrounding magnetic field caused by movement of the float 1 in an up and down direction inside the pipe 2 as shown in FIGS. 5(c) and (d), and thus, a magnetic field of a polarity opposite to the magnetic field applied until then is applied to the magnetic sensor 3.

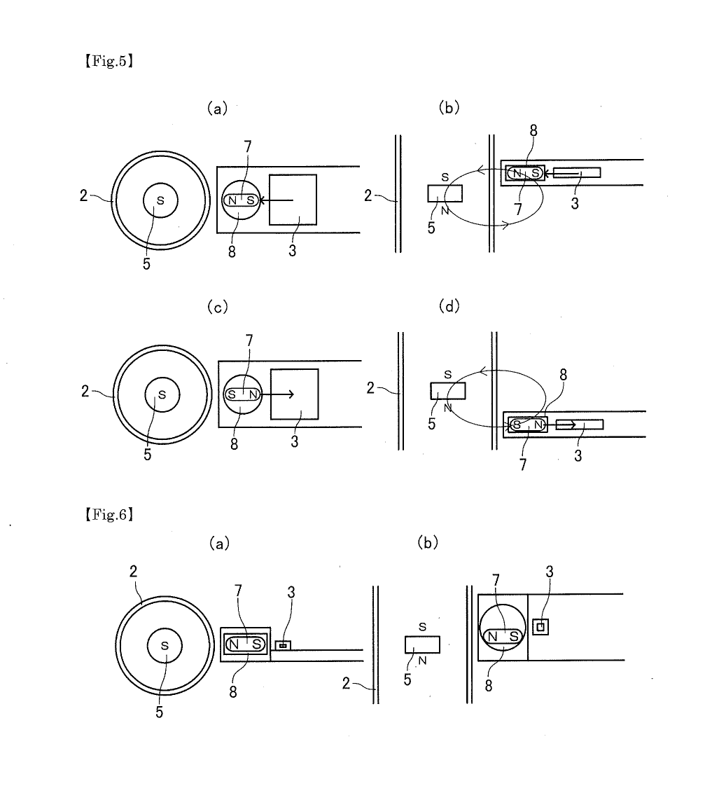

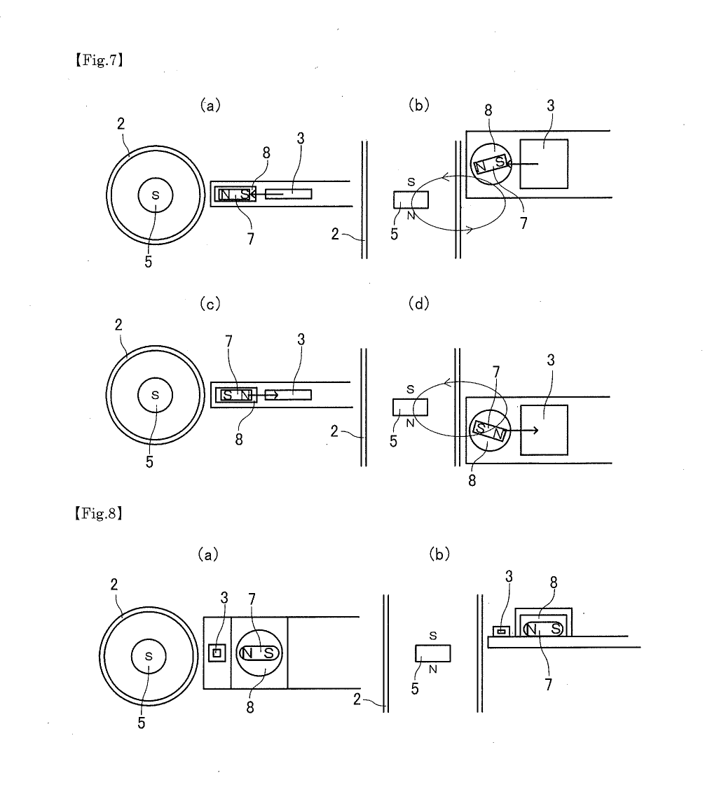

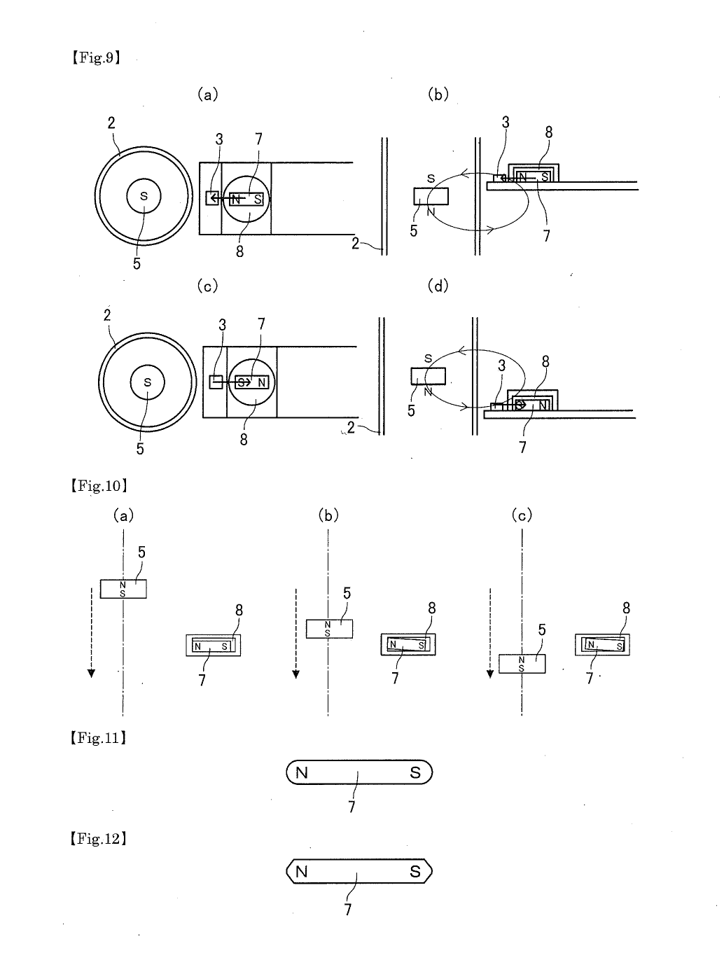

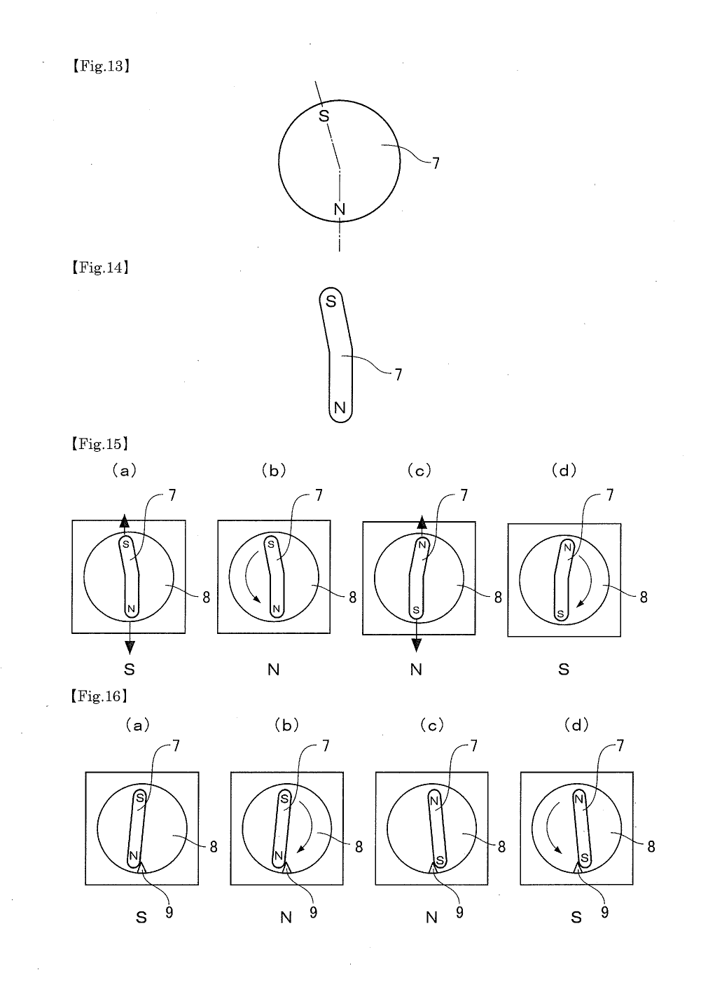

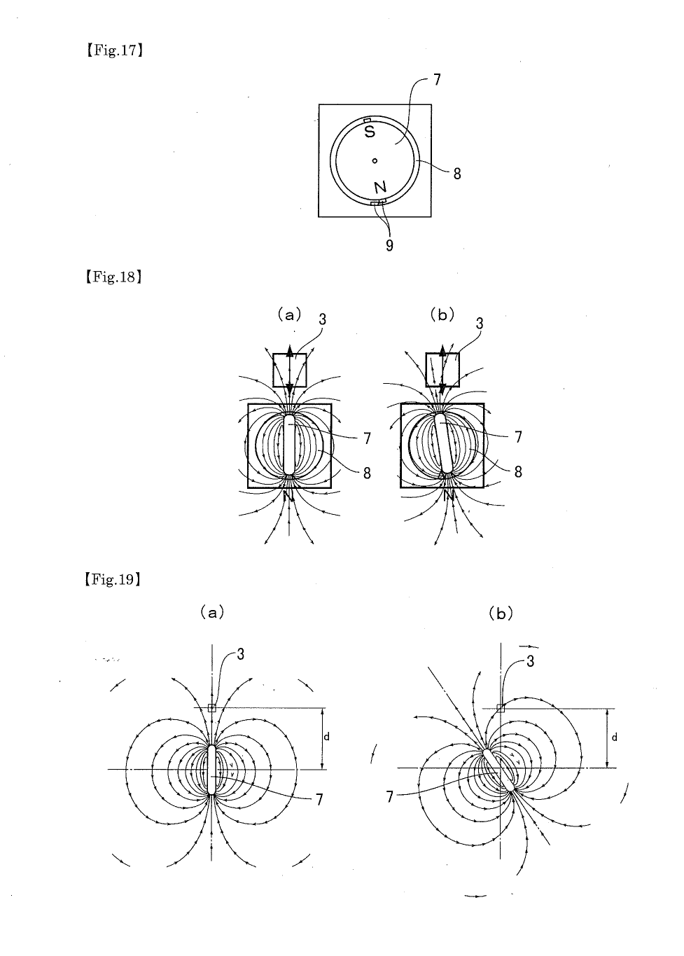

The example in which the magnet 7 is rotated in the horizontal surface has been explained in above FIG. 3 and FIG. 5, however, it is possible to apply a structure in which the magnet 7 is pivotally supported and rotated in a direction intersecting with the movement direction of the float 1 as shown in FIG. 6. From the initial state shown in FIGS. 7(a) and (b), the magnet 7 is rotated in a direction of a vertical surface and the orientation of the magnet 7 is changed with respect to the initial state due to the change of the surrounding magnetic field caused by the movement of the float 1 in the up and down direction inside the pipe 2 as shown in FIGS. 7(c) and (d), and thus, a magnetic field of a polarity opposite to the magnetic field until then is applied to the magnetic sensor 3.

The example in which the magnet 7 is disposed between the movement direction of the float 1 and the magnetic sensor 3 has been explained with respect to above FIG. 3 to FIG. 7, however, the magnet 7 may be arranged on the opposite side of the magnetic sensor 3 with respect to the float 1 as shown in FIG. 8 as long as the magnet 7 is positioned in the vicinity of the magnetic sensor 3.

Also in this case, from the initial state shown in FIGS. 9(a) and (b), the magnet 7 is rotated in the horizontal surface and the orientation of the magnet 7 is changed with respect to the initial state due to the change of the surrounding magnetic field caused by the movement of the float 1 in the up and down direction inside the pipe 2 as shown in FIGS. 9(c) and (d), and a magnetic field of a polarity opposite to the magnetic field applied until then is applied to the magnetic sensor 3.

The magnet 7 is rotated and changes the orientation of magnetic poles according to the position of the float 1, however, there is a case where the magnet 7 is not rotated and maintains a repelling state with respect to the float 1 according to the shape of the magnet 7. If a stable equilibrium point exists, the magnet 7 is repelled and pushed to a deep side of the casing 8 even when repulsion/attraction force is generated, however, the magnet is not always rotated.

Specifically, as shown in FIG. 10, (a) as the float located at an upper position comes down, the magnet 7 is pulled by S-pole of the float 1 and abuts on a wall of the casing 8 in a state of (b), and (c) when the float 1 further comes down, N-pole of the magnet 7 receives the repulsion force by N-pole of the float 1 and the magnet 7 abuts on the wall of the casing 8, and thus the magnet 7 is not rotated.

It is preferable that end portions of the magnet 7 have a shape not interfering with the rotation for avoiding the above problem. Specifically, as shown in FIG. 11, end portions on pole's sides of the magnet 7 are formed in a spherical shape or, as shown in FIG. 12, end portions on pole's sides are formed in a cone shape, and further, tips are formed to be rounded for preventing them from being caught. The stable equilibrium can be prevented to occur by forming the magnet 7 as described above.

In order to form the magnet 7 to have the shape not interfering with the rotation, shapes shown in FIG. 13 and FIG. 14 can be applied in addition to the shapes shown in FIG. 11 and FIG. 12. In FIG. 13 and FIG. 14, lines connecting between N-pole and S-pole of the magnet 7 are not straight (180 degrees) but are bent (for example, 170 degrees).

FIG. 15 shows a posture of the magnet 7 changing with the movement of the float 1 in the case where the magnet having the shape shown in FIG. 14 is used as the magnet 7.

When S-pole of the float 1 comes close, the magnet 7 is rotated and becomes in a state of FIG. 15(a). At this time, S-pole of the magnet 7 repels S-pole of the float 1. However, as the attraction force of S-pole of the float 1 with respect to N-pole of the magnet 7 is larger than the repulsion force thereof with respect to S-pole, the rotation is stopped in the state of FIG. 15(a) . Next, when N-pole of the float 1 comes close, N-pole of the magnet 7 receives the repulsion force and S-pole receives the attraction force. As S-pole of the magnet 7 is bent to the left side in the example of FIG. 15(b) at this time, the magnet 7 is rotated in a direction of an arrow in FIG. 15(b), and stopped at a position of FIG. 15(c). After that, when S-pole of the float 1 comes close, the magnet 7 is rotated in a direction in which the magnet 7 is bent in the same manner as described above as shown in FIG. 15(d).

As described above, it is possible to realize positive operation without occurrence of stable equilibrium by using the magnet 7 in which the line connecting between N-pole and S-pole of the magnet 7 is bent (for example, 170 degrees).

The float 1 does not move at high speed as the float 1 normally moves in accordance with variations of the flow of fluid. However, there rarely exists a flowmeter in which the float 1 moves at high speed. When the float 1 moves at high speed, the float 1 passes through before fixing a pole in reverse phase after giving a rotating force to the magnet 7, therefore, the magnet 7 continues rotating through inertia, as a result, the magnet 7 stops in an undesirable state. In order to avoid excessive rotation and to make the operation secure as well as to simplify the shape of the magnet, it is effective to provide a protruding rotation stopper 9 shown in FIG. 16 on an inner wall of the casing 8. In the casing 8 in the example shown in FIG. 16, the protrusion 9 for interfering with the rotation of the bar magnet is provided on the inner wall. The protrusion 9 for stopping the rotation is formed to have the size in which the bar magnet can be prevented from rotating. For example, when the casing 8 having a cylindrical shape shown in FIG. 16 is used, it is necessary that a length obtained by adding a length of the longest portion in the longitudinal direction of the bar magnet to a height of the protrusion exceeds a length of the diameter of the casing 8. Accordingly, the excessive rotation of the magnet 7 can be prevented by the protrusion 9 even when the float 1 moves at high speed, which ensures normal operation.

It is also preferable that the protrusion 9 is provided on the inner wall of the casing 8 at a portion corresponding to a shortest position from the float 1 as shown in FIG. 16. Because, when the protrusion 9 is provided at the position, a straight line of the magnet 7 in the longitudinal direction at the stopped position, when the magnet 7 is rotated and stopped by the attraction of S-pole or N-pole of the float 1, is inclined with respect to a reference straight line obtained when the magnet 7 is stopped in a state in which the protrusion 9 is not provided. Accordingly, directions in which N-pole and S-pole of the magnet 7 are rotated are respectively determined in the same manner as in the case of FIG. 15 explained in the above, which does not create stable equilibrium.

Furthermore, it is sufficient that a molding die for the protrusion 9 is designed to add a protruding portion to the casing 8, or to create a protrusion on the inner wall by making a recession in the outer wall of a portion where the protrusion 9 is formed, therefore, costs are not increased in any degree.

Similarly, also in a case where a disc-type magnet with an axis is used as the magnet 7, the protrusions 9 as rotation stoppers are provided both on the magnet 7 and on the inner wall of the casing 8, thereby fixing the rotation direction and ensuring the rotation. In the example shown in FIG. 17, the protrusion 9 is provided on the inner wall of the casing 8 at a position corresponding to the shortest position from the float 1 in the same manner as the casing 8 of the above bar magnet. The protrusions 9 are also provided on the surface of a side surface portion of the magnet 7 at two points of magnetic poles. These protrusions 9 preferably have a height in which the protrusion 9 on the inner wall of the casing 8 touches the protrusions on the magnet 7 at the time of rotation of the magnet 7 so that the rotation is prevented.

The protrusions are formed in an approximately triangular shape and an approximately rectangular shape respectively in the example of FIG. 16 and FIG. 17, however, the protrusions are not limited to these shapes as long as excessive rotation of the magnet 7 can be prevented.

When the protrusion 9 is provided at the above position of the casing 8, the straight line of the bar magnet in the longitudinal direction and a magneto-sensitive axis of the magnetic sensor 3 are not parallel to each other as shown in FIG. 18(a) but become as shown in FIG. 18(b). However, there is no problem if they are not parallel to each other, as long as magnetic force lines with the same polarity are applied.

An allowable inclined angle of the bar magnet in the longitudinal direction when using the magneto-sensitive axis of the magnetic sensor 3 as a reference is concerned with positions of the magnet 7 and the sensor device. FIG. 19 represents a simulation performed by setting a length of the bar magnet to 8 mm and setting a distance from the center of the bar magnet 7 to the sensor device to 12 mm. It is found from FIG. 19(b) that the magnetic force has a vector component in the direction of the magneto-sensitive axis at the position of the sensor device even when the magnet is inclined 35 degrees from the magneto-sensitive axis of the magnetic sensor 3 as the reference. The magnet can be used when the vector component in the direction of the magneto-sensitive axis exceeds the sensitivity of the sensor. For example, in a magnet having a surface magnetic flux density of 1000 gauss, a magnetic flux in the direction of the magneto-sensitive axis at the sensor position in FIG. 19(b) is approximately 25 oersted, which has an intensity sufficiently usable in the normal magnetic sensor 3.

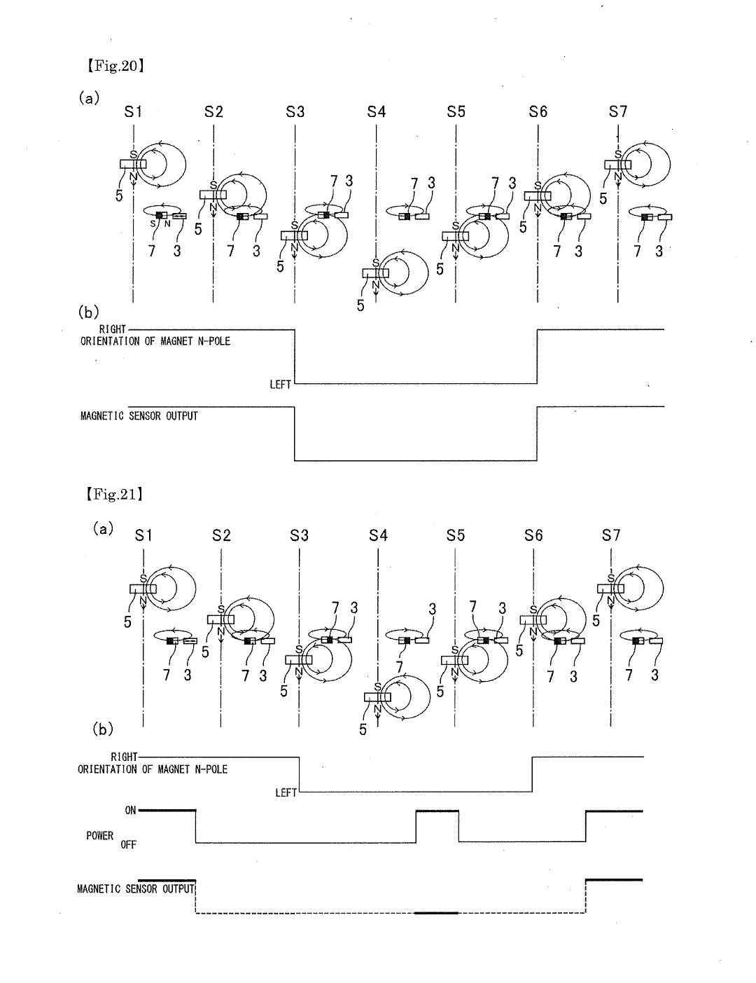

Next, the relation between the status of the magnet 7 and the output of the magnetic sensor 3 will be specifically explained with reference to FIG. 20. FIG. 20(a) represents, in the order from the left, states (S1) to (S4) in which the magnet 5 moves in a direction coming close to the magnetic sensor 3 (downward direction) and states (S4) to (S7) in which the magnet 5 moves upward after reaching a lower end (S4). FIG. 20(b) represents the orientation of N-pole of the magnet 7 and a signal output from the magnetic sensor 3 so as to correspond to FIG. 20(a).

The magnetic sensor 3 senses the magnetic field from the magnet 7 and outputs a signal.

The magnet 7 is rotated and changes the orientation when the intensity of the magnetic field received from the float 1 exceeds a given value ((S3) and (S6)). Then, the magnet 7 continues applying the magnetic field to the magnetic sensor 3 even when the float 1 moves away ((S3) to (S5)).

Subsequently, a modification example of the example explained in FIG. 20 will be explained with reference to FIG. 21. As shown in FIG. 21(b), the power is turned off in (S2) to (S4) as well as (S6) and the power is on in periods other than the above. As apparent from the FIG. 21(b), both the float 1 and the magnet 7 can be moved during periods in which the power is off, therefore, the magnetic sensor 3 can sense a correct position of the float 1 and can output the signal when the. power is turned on again at (S6).

### DESCRIPTION OF REFERENCE NUMERALS AND SIGNS

1 float
2 pipe
3 magnetic sensor
4 switch circuit
5 magnet
6 comparator
7 magnet
8 casing
9 protrusion

1. A float position sensor comprising:
a float; and
a magnetic sensor provided in a lateral direction with respect to a movement direction of the float for detecting a change of a magnetic field caused by movement of the float,
wherein the change of the magnetic field caused by the movement of the float is detected by the magnetic sensor through a movable magnet provided in the vicinity of the magnetic sensor.

2. The float position sensor according to claim 1,
wherein the movable magnet is provided between the movement direction of the float and the magnetic sensor, or on the opposite side of the magnetic sensor with respect to the float.

3. The float position sensor according to claim 1,
wherein the magnet is pivotally supported to be rotatable by an axis parallel to the movement direction of the float.

4. The float position sensor according to claim 1,
wherein the magnet is arranged in a casing for controlling movement in a direction coming close to or a direction moving away from the movement direction of the float.

5. The float position sensor according to claim 4,
wherein a protrusion for controlling a range in which the magnet is rotated is provided on an inner wall of the casing.

6. The float position sensor according to claim 1,
wherein the magnet is a columnar or disc-shaped multipolar magnet.

7. The float position sensor according to claim 1,
wherein end portions on pole's sides of the magnet are formed in a cone shape or a spherical shape.

8. The float position sensor according to claim 1,
wherein the magnet is formed so that a line connecting between both poles is bent.
